(19) United States
(12) Patent Application Publication
(10) Pub. No.: US 2010/0031813 A1
(43) Pub. Date: Feb. 11, 2010

(54) RODLESS CYLINDER DEVICE

(75) Inventor: Takashi Ejiri, Tokyo (JP)

Correspondence Address: MCCORMICK, PAULDING & HUBER LLP, CITY PLACE II, 185 ASYLUM STREET, HARTFORD, CT, 06103, US

(73) Assignee: Fujikura Rubber Ltd., Tokyo (JP)

(21) Appl. No.: 12/517,564

(22) PCT Filed: Nov. 14, 2007
(86) PCT No.: PCT/JP2007/072095

§ 371 Date: Jun. 4, 2009

(30) Foreign Application Priority Data
Dec. 8, 2006 (JP) 2006-331997

(51) Int. Cl. F15B 15/14

(52) U.S. Cl. 92/88

(57) ABSTRACT

A rodless cylinder device includes a piston body integrated with the central top portion of a rolling diaphragm, a cylinder body which fixes the circumferential annular fixing portion of the rolling diaphragm and in which the piston body is fitted to be freely movable, a slit which is formed in the cylinder body to extend therethrough and elongated in an axial direction, an inner-to-outer connector fixed to the piston body and projecting outwardly through the slit, an external moving body positioned outside the cylinder body and fixed to the inner-to-outer connector, and a supply and exhaust mechanism, formed between the rolling diaphragm, the cylinder body and the piston body, the supply and exhaust mechanism supplying and exhausting a pressure fluid to and from a pressure chamber.

### TECHNICAL FIELD

The present invention relates to a rodless cylinder device.

### BACKGROUND OF THE INVENTION

A conventional type of rodless cylinder device in which a piston body and a slider (moving body) are slidably fitted into and onto a cylinder, respectively, and in which the piston body and the slider are provided with a permanent magnet and another permanent magnet which attract each other, respectively, so that the slider moves with the piston body is known in the art (Patent Document 1). In addition, another type of rodless cylinder device in which a slit is formed in a cylinder to extend in the axial direction thereof so that a piston body (piston yoke) and a piston mount which are respectively installed inside and outside the cylinder are coupled to each other through the slit and in which an inner sealing band and an outer sealing band are respectively installed inside and outside the cylinder along the slit is also known in the art (Patent Document 2).

### Patent Document 1: Japanese Unexamined Patent Publication No. 2000-27809

### Patent Document 2: Japanese Unexamined Patent Publication No. 2001-165116

### DISCLOSURE OF THE INVENTION

### Problem to be Solved by the Invention

However, in the former rodless cylinder device, permanent magnets are indispensable elements, which complicates the structure of the rodless cylinder device and increases the size thereof. In the latter rodless cylinder device, the structure thereof around the inner and outer sealing bands is complicated, so that the rodless cylinder device has a problem with long-term sealing performance, the frictional resistance is great, and the rodless cylinder device is not suitable for use in a low-pressure operation.

Accordingly, an objective of the present invention is to achieve a rodless cylinder device having a simple structure which is capable of easily assuring sealing performance over a long term and capable of operating at low pressure with no frictional resistance. In addition, another objective of the present invention is to achieve a rodless cylinder device in which the stroke of the external moving body can be made long for the length of the cylinder body.

### Means for Solving the Problem

The rodless cylinder device of present invention is characterized in that it includes a rodless cylinder device including a rolling diaphragm which includes a circumferential annular fixing portion, a folded cylindrical portion and a central top portion; a piston body integrated with the central top portion of the rolling diaphragm; a cylinder body which fixes the circumferential annular fixing portion of the rolling diaphragm and in which the piston body is fitted to be freely movable therein; a slit which is formed in the cylinder body to extend therethrough and elongated in an axial direction; an inner-to-outer connector fixed to the piston body and projecting outwardly through the slit; an external moving body positioned outside the cylinder body and fixed to the inner-to-outer connector; and a supply and exhaust mechanism formed between the rolling diaphragm, the cylinder body and the piston body, the supply and exhaust mechanism supplying and exhausting a pressure fluid to and from a pressure chamber.

The slit of the cylinder body is formed across the moving range of the folded cylindrical portion of the rolling diaphragm so that the rolling diaphragm is exposed through said slit as the piston body reciprocally moves, a rodless cylinder device can be achieved in which the stroke of the external moving body is long for the length of the cylinder body.

It is practical to configure the cylinder body so as to include a central cylinder including the slit, and a pair of bonnets which are joined to both ends of the central cylinder, respectively.

A double-acting type of rodless cylinder device is achieved by holding circumferential annular fixing portions of a pair of rolling diaphragms between the central cylinder and the pair of bonnets, and fixing central top portions of the pair of rolling diaphragms to both ends of the piston body, respectively.

The central cylinder and the pair of bonnets can be joined together by a plurality of tie rods, some of the plurality of tie rods can also be used as guide bars for the external moving body.

The rolling diaphragm rolls while being pressed against the inner edge of the slit at a high contact pressure when receiving a pressure which attempts to escape outwardly through the slit. Therefore, the inner edge (portion with which the rolling diaphragm is in contact) of the slit must be carefully given a smooth finish if the cylinder body, in particular, is formed from an aluminum alloy or another metal, or even if formed from a synthetic resin. It is desirable that a protective resin layer be formed on the cylinder body at least along the inner edge of the slit after the slit is formed in the cylinder body.

The protective resin layer is cost effective if formed from a self-adhesive tape made of synthetic resin or a cellophane self-adhesive tape (regenerated cellulose). Specifically, any one of silicon-resin self-adhesive tape, polytetrafluoroethylene self-adhesive tape, vinyl-chloride resin self-adhesive tape, and cellophane self-adhesive tape can be used. Furthermore, it is desirable for a thickness of the self-adhesive tape to be in the range of 0.01 mm through 0.10 mm. It is, of course, desirable for the self-adhesive tape made of synthetic resin to be adhered to the cylinder body along the inner edge of the slit if the cylinder body is made of metal, and it is also desirable even if the cylinder body is made of synthetic resin.

### BRIEF DESCRIPTION OF THE DRAWINGS

FIG. 1 is a front elevational view of an embodiment of a rodless cylinder device according to the present invention;

FIG. 2 is a cross sectional view taken along the line II-II shown in FIG. 1;

FIG. 3 is a cross sectional view taken along the line III-III shown in FIG. 2;

FIG. 4 is an exploded perspective view of the rodless cylinder device;

FIG. 5 is a cross sectional view similar to that of FIG. 3, showing another embodiment of the rodless cylinder device;

FIG. 6 is a perspective view of a central cylinder of a cylinder body, showing another embodiment of the rodless cylinder device according to the present invention; and

FIG. 7 is a cross sectional view taken along the line VII-VII shown in FIG. 6.

### PREFERRED EMBODIMENTS OF THE INVENTION

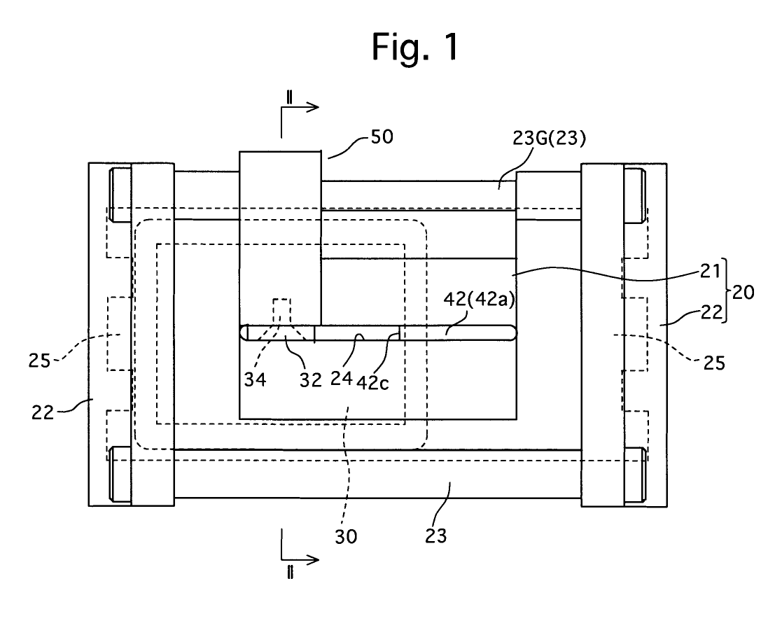

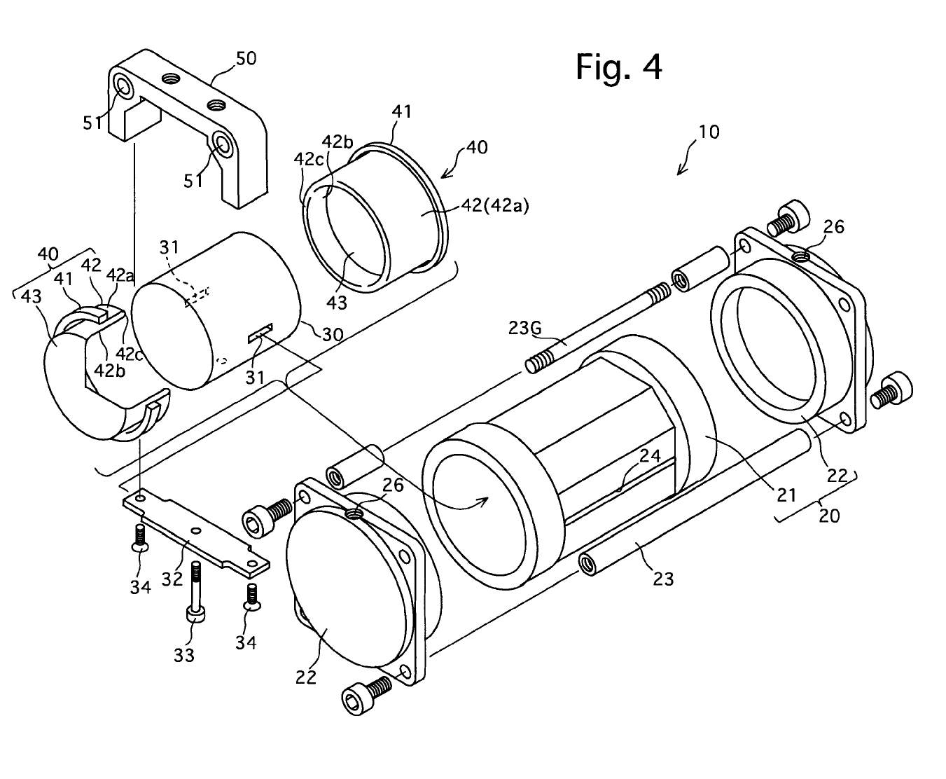

FIGS. 1 through 4 show a first embodiment of a rodless cylinder device 10 according to the present invention. The rodless cylinder device 10 is bilaterally symmetrical in structure and provided with a cylinder body 20, a piston body 30, a pair of rolling diaphragms (R-diaphragms) 40 and an external moving body 50, which are principal elements of the rodless cylinder device 10.

The cylinder body 20 is composed of a central cylinder 21 positioned at a center thereof, and a pair of bonnets 22 which are joined to both ends of the central cylinder 21, respectively.

Each R-diaphragm 40 is made from a flexible rubber material having a foundation cloth, for enhancing pressure resistance, embedded therein. Each R-diaphragm 40 is formed into a rotationally-symmetrical shape about the central axis, including a circumferential annular bead portion (fixing portion) 41, a folded cylindrical portion 42 and a central top portion (diaphragm top portion) 43. The folded cylindrical portion 42 is provided with an outer cylindrical portion 42a, an inner cylindrical portion 42b and a folded portion 42c. When the relative position between the circumferential annular bead portion 41 and the central top portion 43 varies in the axial direction, the folded cylindrical portion 42 follows this variation while changing the position of the folded portion 42c. The pair of R-diaphragms 40 of this kind is known in the art.

The pair of R-diaphragms 40 are orientated in opposite directions, the circumferential annular bead portion 41 of each R-diaphragm 40 is held between associated one of both ends of the central cylinder 21 and associated one of the pair of bonnets 22, and the central top portions 43 are adhered to both end surfaces of the piston body 30, respectively, to be integral therewith. The central cylinder 21 of the cylinder body 20 and the piston body 30 are not in contact with each other (an annular gap exists therebetween), the outer cylindrical portion 42a is positioned along an inner peripheral surface of the central cylinder 21 of the cylinder body 20, and the inner cylindrical portion 42b is positioned along an outer peripheral surface of the piston body 30.

The central cylinder 21 and the pair of bonnets 22 that are positioned at both ends of the central cylinder 21 are joined together by tie rods 23 (four tie rods 23 in the illustrated embodiment) which are parallel to the axis of the cylinder body 20. Some of the tie rods 23 (23G) (two tie rods in the illustrated embodiment) are inserted into bushes (roller bearings or slide bearings) 51 of the external moving body 50 to be relatively freely slidable and also serve as guide bars 23G for the external moving body 50. The external moving body 50 is positioned outside the cylinder body 20 (the central cylinder 21) and is movable in the axial direction of the cylinder body 20 along the guide bars 23G.

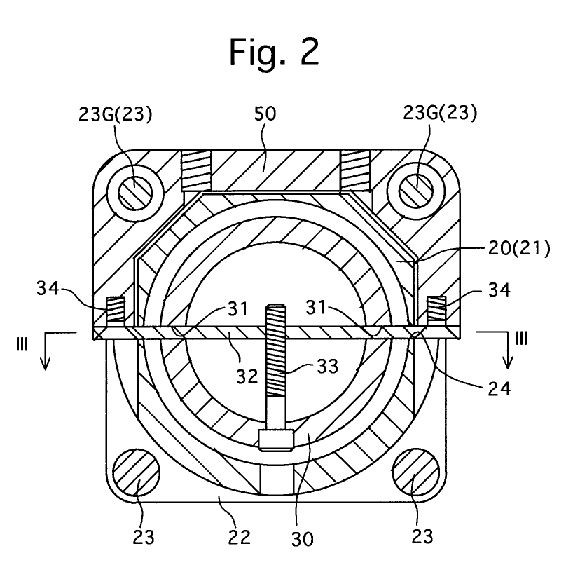

The central cylinder 21 of the cylinder body 20 is provided at diametrically opposed positions with two slits 24, respectively, which extend in a direction parallel to the axis of the central cylinder 21. Likewise, the piston body 30 is provided at diametrically opposed positions with two slits 31, respectively. An inner-to-outer connecting plate (inner-to-outer connector) 32 which is inserted through the slits 31 is fixed to the piston body 30 by a set screw 33 (see FIG. 2). Both ends of the inner-to-outer connecting plate 32 pass through the slits 24 of the cylinder body 20 and project outwardly, respectively, and are fixed to the external moving body 50 by two set screws 34, respectively.

The axial length of each slit 24 is predetermined to be great so that the outer cylindrical portion 42a and the folded portion 42c of each R-diaphragm 40 is exposed through each slit 24 when the piston body 30 moves reciprocally in the cylinder body 20. The forward movement limit and the reverse movement limit of the external moving body 50 are determined by the contact engagement of the piston body 30 with a stopper in the left bonnet 22 and a stopper in the right bonnet 22, respectively.

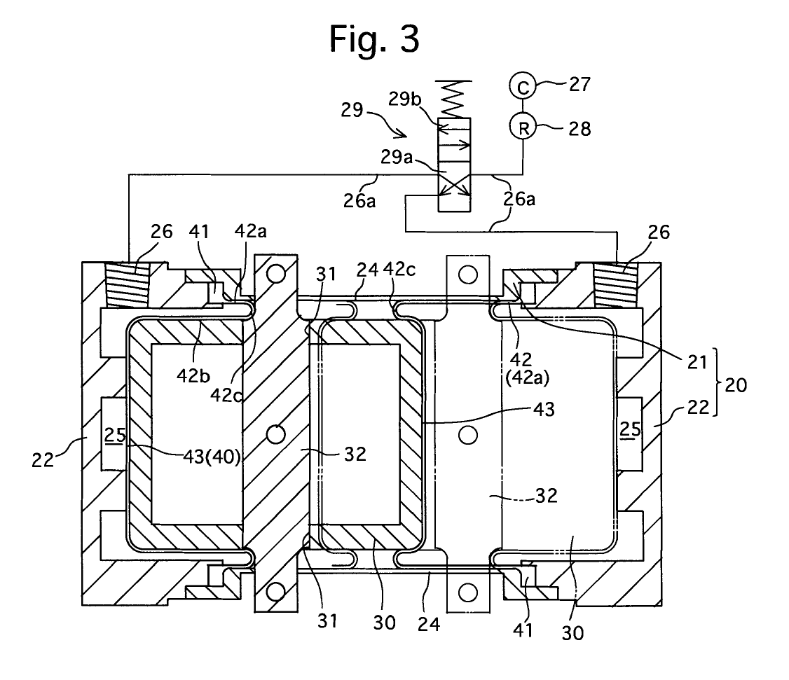

A pair of pressure chambers 25 are formed in the cylinder body 20 by the central cylinder 21, the pair of bonnets 22 and the pair of R-diaphragms 40 (the piston body 30). The pair of bonnets 22 at both ends of the cylinder body 20 are bored to form a pair of air ports 26 which are communicatively connected to the pair of pressure chambers 25, respectively. As shown in FIG. 3, a compressed air source 27, a regulator 28 and a switching value 29 are connected to the pair of air ports 26 via conduits 26a, so that pressurized air can be selectively supplied to the pair of air ports 26. Namely, pressurized air is supplied to the right pressure chamber 25 with respect to FIG. 3 so that the piston body 30 moves leftward when a port 29a of the switching valve 29 is connected to one of the conduits 26a that are communicatively connected to the pair of air ports 26, and pressurized air is supplied to the left pressure chamber 25 with respect to FIG. 3 so that the piston body 30 moves rightward when a port 29b of the switching valve 29 is connected to the other conduit 26a.

Accordingly, in a state where the compressed air source 27 and the regulator 28 are in operation, the rodless cylinder device 10 that has the above described structure can move the piston body 30 leftward and rightward by connecting the port 29a and the port 29b of the switching valve 29 to the conduits 26a, respectively. Since the external moving body 50 is joined integrally to the piston body 30 via the inner-to-outer connecting plate 32, the external moving body 50 can be made to work.

The present embodiment of the rodless cylinder device 10 is composed of the cylinder body 20, the piston body 30, the pair of R-diaphragms 40 and the external moving body 50, which are principal elements of the rodless cylinder device 10, and the shapes of these principal elements are simple. Since the piston body 30 and the external moving body 50 are mechanically connected to each other by the inner-to-outer connecting plate 32 that passes through the slits 24, motion of the piston body 30 is securely transmitted to the external moving body 50. In addition, no problem arises with the sealing capability because the pair of pressure chambers 25 are formed by the pair of R-diaphragms 40. Since there is no output rod which requires a rod seal and a bearing, no friction occurs, and the overall length can be curbed.

Specifically, in the present embodiment, the stroke (moving amount) of the piston body 30 (the external moving body 50) can be made long compared to the length of the cylinder body 20 since the axial length of each slit 24 is predetermined to be great so that the outer cylindrical portion 42a and the folded portion 42c of each R-diaphragm 40 is exposed through each slit 24 when the piston body 30 moves reciprocally in the cylinder body 20.

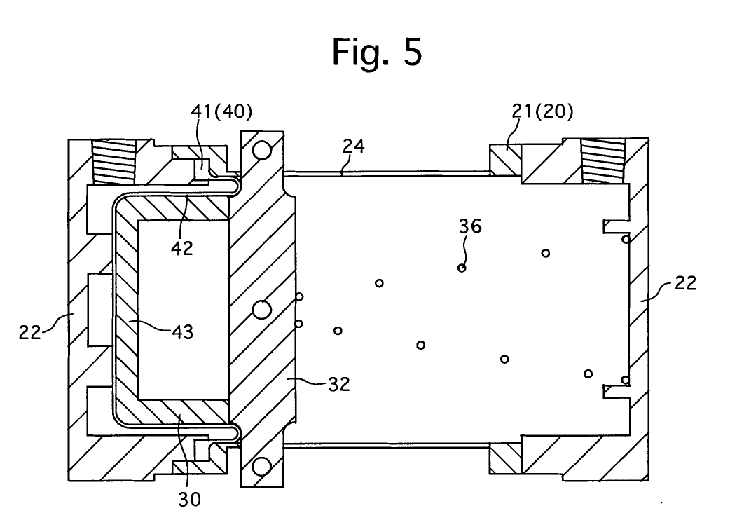

The above described embodiment is of a double-acting type in which the two pressure chambers 25 are formed on both sides of the piston body 30, whereas the embodiment shown in FIG. 5 is of a single acting type according to the present invention in which one of the pair of R-diaphragms 40 at both ends of the piston body 30 is replaced by a compression coil spring 36. The elements except for the compression coil spring 36 are the same as those of the previous embodiment and designated by the same reference numerals.

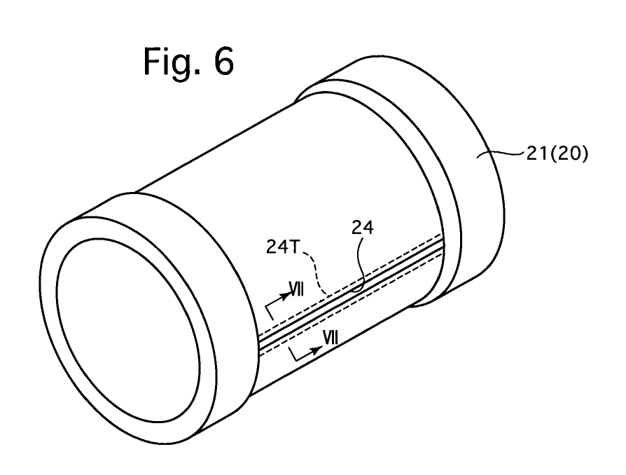

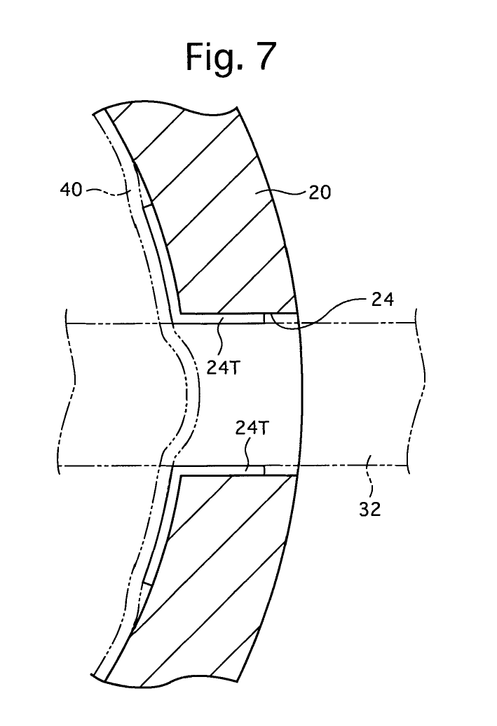

FIGS. 6 and 7 show another embodiment of the rodless cylinder device according to the present invention. In this embodiment, the inner edges of each slit 24 of the central cylinder 21 that is an element of the cylinder body 20 are covered by self-adhesive tapes 24T. Even if a portion of each/either R-diaphragm 40 slides on the inner edges (the slits 24) of a rigid body (the cylinder body 20) while moving (even if each slit 24 is formed across the moving ranges of the folded cylindrical portions 42 of the pair of R-diaphragms 40 and if a portion of each R-diaphragm 40 is exposed through each slit 24 as the piston body 30 reciprocally moves), it has been confirmed that the durability of the R-diaphragms 40 is not adversely affected even without the self-adhesive tapes 24T of this kind so long as the surface precision (surface roughness) in the vicinity of the inner edges of the slits 24 is made sufficiently high (smooth). However, if the self-adhesive tapes 24T are adhered to the inner edges of the slits 24, the durability of each R-diaphragm 40 can be easily improved at an extremely low cost. The range (length) of adherence of the self-adhesive tapes 24 is determined to correspond to the range of engagement of the folded cylindrical portion 42 of each R-diaphragm 40 with the self-adhesive tapes 24. FIG. 7 schematically shows the shape of a resiliently deformed R-diaphragm 40 with the self-adhesive tapes 24T being adhered.

Although the material of the self-adhesive tapes 24T is not limited to a specific material and can be selected from among known materials available on the market, for instance, one of the following specific self-adhesive tapes: silicon-resin self-adhesive tape, polytetrafluoroethylene (PTFE) self-adhesive tape, vinyl-chloride resin self-adhesive tape, and cellophane self-adhesive tape can be used. More specifically, the specific product names of such self-adhesive tapes are, e.g., NITOFLON adhesive tape (made by NITTO DENKO CORPORATION) and CHUKOH fluoroplastic adhesive tape (tape type: ASF-110, made by Chukoh Chemical Industries, Ltd.). In addition, it is desirable that the tape thickness be in the range of approximately 0.01 mm through 0.10 mm. There is a possibility of the self-adhesive tape being broken in an adhering operation or other operation if the tape thickness is smaller than 0.01 mm. If the tape thickness is greater than 0.10 mm, substantial surface steps are created by the self-adhesive tapes 24T in the vicinity of the slits 24, which is undesirable. Since the inner-to-outer connecting plate 32 is inserted through the slits 24 as shown by chain lines in FIG. 7, the thickness of the inner-to-outer connecting plate 32 is determined in consideration of the thickness of the self-adhesive tapes 24T.

The self-adhesive tapes 24T are desirably used to form protective resin layers on the inner edges of the slits 24 easily at a low cost. However, such protective resin layers can be formed by other means such as applying a coating or baking. Additionally, although the necessity of the self-adhesive tapes (protective resin layers) 24T is high in the case where the cylinder body (the central cylinder 21) is made of an aluminum alloy or other metallic materials, the self-adhesive tapes 24T are effective at enhancing the profile irregularity of the central cylinder 21 in the vicinity of the slits 24 also in the case where the central cylinder 21 is made of synthetic resin.

### INDUSTRIAL APPLICABILITY

According to the present invention, a rodless cylinder device of simple structure with a high level of sealing performance can be achieved. In addition, the stroke of the external moving body can be made long with respect to the length of the cylinder body.

1-9. (canceled)

10. A rodless cylinder device comprising:
a rolling diaphragm which includes a circumferential annular fixing portion, a folded cylindrical portion and a central top portion;
a piston body integrated with said central top portion of said rolling diaphragm;
a cylinder body which fixes said circumferential annular fixing portion of said rolling diaphragm and in which said piston body is fitted to be freely movable therein, wherein said piston body and said cylinder body are in noncontact with each other, and wherein said folded cylindrical portion of said rolling diaphragm is positioned along an outer peripheral surface of said piston body and an inner peripheral surface of said cylinder body;
a slit which is formed in said cylinder body to extend therethrough and elongated in an axial direction;
an inner-to-outer connector fixed to said piston body and projecting outwardly through said slit;
an external moving body positioned outside said cylinder body and fixed to said inner-to-outer connector; and
a supply and exhaust mechanism formed between said rolling diaphragm, said cylinder body and said piston body, said supply and exhaust mechanism supplying and exhausting a pressure fluid to and from a pressure chamber,
wherein said slit is formed across a moving range of said folded cylindrical portion of said rolling diaphragm, and said folded cylindrical portion rolls while being pressed against an inner side of said slit as said piston body reciprocally moves.

11. The rodless cylinder device according to claim 10, wherein said cylinder body comprises: a central cylinder including said slit; and a pair of bonnets which are joined to both ends of said central cylinder, respectively.

12. The rodless cylinder device according to claim 11, wherein circumferential annular fixing portions of a pair of rolling diaphragms are held between said central cylinder and said pair of bonnets, and
wherein central top portions of said pair of rolling diaphragms are fixed to both ends of said piston body, respectively.

13. The rodless cylinder device according to claim 11, wherein said central cylinder and said pair of bonnets are joined together by a plurality of tie rods, some of said plurality of tie rods being also used as guide bars for said external moving body.

14. The rodless cylinder device according to claim 11, wherein a protective resin layer is formed on said cylinder body at least along an inner edge of said slit that is formed in said cylinder body.

15. The rodless cylinder device according to claim 14, wherein said protective resin layer comprises a self-adhesive tape.

16. The rodless cylinder device according to claim 15, wherein said self-adhesive tape comprises one of the following: silicon-resin self-adhesive tape, polytetrafluoroethylene self-adhesive tape, vinyl-chloride resin self-adhesive tape, and cellophane self-adhesive tape.

17. The rodless cylinder device according to claim 15, wherein a thickness of said self-adhesive tape is in the range of 0.01 mm through 0.10 mm.
